(19) United States
(12) Patent Application Publication
(10) Pub. No.: US 2004/0186865 A1
(43) Pub. Date: Sep. 23, 2004

(54) Method and device for reducing the crest factor of a signal

(75) Inventor: Heinrich Schenk, Munchen (DE)

Correspondence Address: Maginot, Moore & Beck, Bank One Tower, 111 Monument Circle, Suite 3000, Indianapolis, IN, 46204, US

(73) Assignee: Infineon Technologies AG, Munich (DE)

(21) Appl. No.: 10/763,046

(22) Filed: Jan. 21, 2004

(30) Foreign Application Priority Data
Jan. 21, 2003 (DE) 103 02 161.2

(51) Int. Cl. G06F 7/00

(52) U.S. Cl. 708/200

(57) ABSTRACT

In a signal which is used, in particular, for data transmission by the method of discrete multitone modulation, in order to change and in particular to reduce the crest factor, it is known to store the signal in the form of individual sampling values in a signal vector (y), as a function of which, a correction vector (Δy) is calculated to be superimposed on the signal vector (y). When the frequency components of the corrected signal vector are to be changed by filtering, the crest factor is in certain circumstances disadvantageously increased again. According to the invention, to change the crest factor, the correction vector (Δy) is therefore superimposed on the signal vector (y) after prior filtering. Advantageously, the sampling frequency is doubled in the prior filtering and the elements of the signal vector (y) which has been doubled with respect to the sampling frequency are alternately divided over two part signal vectors. The crest factor is then changed in that for each part signal vector a correction vector is independently calculated and is superimposed on the respective part signal vector. The corrected part signal vectors are then combined again alternately to form a signal vector which has been doubled with respect to sampling frequency.

The invention relates to a method and a device set up to carry out the method for changing and in particular reducing the crest factor of a signal, the signal being described by a signal vector and at least one correction vector being calculated as a function of the signal vector and being added to the signal vector to change the crest factor of the signal.

The crest factor of a signal provides the ratio of the peak value of the signal to its effective value. With an increasing crest factor, the outlay required for linear processing of the signal also increases. The signal processing in this context comprises, for example, digital-analogue conversion, analogue-digital conversion, analogue or digital filtering, amplification or attenuation and a transmission via a line.

In particular, signals which have been generated in the use of discrete multitone modulation may have a high crest factor. Discrete multitone modulation (DMT)—also multi-carrier modulation—is a modulation method which is suitable in particular for the transmission of data via linearly distorting channels. Application areas for discrete multitone modulation are, for example, digital radio DAB (Digital Audio Broadcast) with the name OFDM (Orthogonal Frequency Division Multiplex) and the transmission of data via telephone lines with the name ADSL (Asymmetric Digital Subscriber Line).

In this modulation method, the transmitting signal is composed of many sinusoidal signals, each individual sinusoidal signal being modulated both with respect to amplitude and to phase. A number of quadrature amplitude-modulated signals are thus obtained. For implementation, inverse Fourier transformation, in particular inverse FFT (Fast Fourier Transformation) can be used in the transmitter, and normal Fourier transformation, in particular FFT (Fast Fourier Transformation) can be used in the receiver.

A data transmission system using the discrete multitone modulation, for example, has a coding device which assigns the bits of a serial digital data signal which is to be transmitted to individual carrier frequencies and generates a digital signal vector in the frequency domain The signal vector is transformed in the frequency domain in the time domain by an inverse fast Fourier transformation (IFFT). The signal shown by the signal vector generated in the time domain has an amplitude distribution which approximately corresponds to a Gauss distribution. A graph of a distribution of this type is shown in FIG. 4, various amplitude values being plotted on the horizontal axis to the right and the frequency n of the occurrence of the individual amplitude values being plotted on the horizontal axis at the top. As can be seen in the graph, even very high amplitude values with a certain, even if low, probability can occur. The crest factor of the signal is therefore very large, so the components of the signal transmission chain following the FFT have to have a very large dynamic range or a high resolution to avoid distortions. To keep the outlay required for this as low as possible, it is known, to reduce the crest factor of the signal in the time domain.

Thus, a method for reducing the crest factor of a signal is known from DE 19850642 A1 for example, in which a correction vector which is added to the signal is calculated from the signal vector, the correction vector being selected in such a way that, on the one hand, the crest factor is reduced and, on the other hand, the spectral components of the correction vector are only located at half the sampling frequency of the signal or at the frequency 0, so only spectral components which do not, or only slightly, interfere with the data to be transmitted are added by the correction vector.

Methods are also known in which, to reduce the crest factor in discrete multitone modulation, carrier frequencies are used which are not used for data transmission. These unused carrier frequencies are in particular distributed uniformly over the fundamental frequency range and thus disadvantageously narrow the band width available for data transmission. A method of this type is known from M. Friese, “Mehrträgermodulation mit kleinem Crest-Faktor”, [Multicarrier modulation with small crest factor] VDI Fortschritt-Berichte, [VDI progress report], series 10, No. 472, Dusseldorf 1997. Furthermore, in this method, a high outlay for circuitry is disadvantageously also required to select and occupy the unused carrier frequencies, and it is necessary to inform a receiver which carrier frequencies have been used to reduce the crest factor.

In the known method, the crest factor is directly reduced after generation of the signal vector in the time domain.

In many applications the reduction of the crest factor is followed by a filter circuit to limit the frequency range of the signal vector generated. In many applications, in particular in systems with a digital transmitting filter with steep filter flanks and a correspondingly long impulse response, the peak value disadvantageously increases again after filtering, so the crest factor deteriorates again.

The object of the present invention is based on providing a method and a correspondingly configured device to change the crest factor of a signal by means of a correction vector calculated as a function of the signal vector and added thereto, wherein the frequency range of the signal vector generated can be limited and an effective reduction of the crest factor is achieved.

This object is achieved according to the invention by a method with the features of claim 1 or a device with the features of claim 16. The sub-claims each define preferred and advantageous embodiments of the present invention.

According to the invention, the signal vector is first filtered and is only then calculated as a function of the filtered signal vector of the at least one correction vector to change and in particular reduce the crest factor of the signal vector and added to the filtered signal vector. The frequency range of the signal or the signal vector can thus be changed and nevertheless an effective change, and in particular reduction, of the crest factor can be achieved.

For the additive correction of the signal vector a correction vector or a plurality of correction vectors can be added thereto and may also be combined in advance to form a single correction vector.

When the signal vector transformed in the time domain passes through a plurality of filtering stages the crest factor is advantageously reduced with the aid of the correction vector after the filtering stage which most strongly increases the crest factor of the signal.

The filtering of the signal may, for example, be a high-pass filtering in data transmission via a telephone line to keep the lower frequency range free for telephone conversations. Furthermore, filtering may comprise a low-pass filtering to remove, prior to transmission via a line, undesired high-frequency signal components which, for example, have been produced by digitalisation, with in particular all frequency components being removed via half the sampling frequency or the Nyquist frequency to avoid violation of the sampling theorem.

The at least one correction vector is calculated in such a way that, after the addition thereof to the signal vector, the data transmitted with the signal are not disturbed and the crest factor of the signal is nevertheless reduced. This may occur, in particular, in that the at least one correction vector is calculated by scaling of at least one output correction vector, of which the spectral components are located in unused frequency ranges. These are, in particular, the frequency 0, i.e. a steady component, or half the sampling frequency, i.e. the Nyquist frequency which is in any case hardly suitable for data transmission as it could only be loaded with a real data symbol. Obviously it is also possible to select the at least one correction vector such that it has a frequency component which is in the fundamental frequency range of the data transmission, the frequency range occupied by the correction vector in this case not being available for data transmission.

In an advantageous embodiment the signal is generated such that the transmitting data have frequency components only up to the sampling frequency of the signal divided by 2^{(N+1)}, where N is integral and ≧1. In this case, the signal values of the signal vector are divided in a cyclically alternating manner over 2^{N} part signal vectors and the reduction in the crest factor is carried out by calculating at least one correction vector independently for each part signal vector. This means that, as a function of each part signal vector, at least one correction vector is calculated and added to the respective part signal vector. The elements of the part signal vectors are then combined again in a cyclically alternating manner to form an output signal vector.

N, in particular, equals 1, so the spectral components of the data are below the sampling frequency of the signal divided by 4 and two part signal vectors exist. Owing to the division of the elements of the signal vector over two part signal vectors, one sinusoidal signal and one cosinusoidal signal can be used in each case with the sampling frequency of the signal divided by 4 for correction as output correction vectors, the sinusoidal signal being applied to one part signal vector and the cosinusoidal signal being applied to the other part signal vector. This mode of operation is possible as in sampling with the sampling frequency in general of a correction signal with a frequency corresponding to a quarter of the sampling frequency, the cosinusoidal or the sinusoidal component always alternately disappears. Owing to the division of the elements of the signal vector over the two part signal vectors, a data block of sampling values with an even time index and another data block with an uneven time index are obtained. The sampling frequency in the two data blocks is half the sampling frequency of the original signal vector.

When Δy1 is the correction vector for the first part signal vector y1 and Δy2 is the correction vector for the second part signal vector y2, k describes the running index for the elements in the vectors and k is ≧1, the two correction vectors can be calculated as follows:

$$Δ y1 = - \frac{1}{2} \cdot {( - 1 )}^{k} ( max ( {( - 1 )}^{k} \cdot {y1}_{k} ) + min ( {( - 1 )}^{k} \cdot {y1}_{k} ) ) , \\ Δ y2 = - \frac{1}{2} \cdot {( - 1 )}^{k} ( max ( {( - 1 )}^{k} \cdot {y2}_{k} ) + min ( {( - 1 )}^{k} \cdot {y2}_{k} ) ) ,$$

where max and min each describe the largest element or the smallest element of the respective part signal vector. The spectral components of the two correction vectors are half the sampling frequency of the part signal vectors or a quarter of the sampling frequency of the original signal vector. From the two correction vectors Δy1 and Δy2 and their part signal vectors y1 and y2, a first sum vector z1 and a second sum vector z2 are calculated for further processing as follows:

z1=y1+Δy1

z2=y2+Δy2.

In addition there is also the possibility of using a correction vector which only adds a steady component. In this case the two correction vectors Δy1 and Δy2 were calculated as follows:

$$Δ y1 = - \frac{1}{2} \cdot ( max ( {y1}_{k} ) + min ( {y1}_{k} ) ) , \\ Δ y2 = - \frac{1}{2} \cdot ( max ( {y2}_{k} ) + min ( {y2}_{k} ) )$$

In the above calculation instructions, the running index k relates to the respective part signal vectors. In other words, k runs from 1 to the number of elements in each part signal vector, or in the case of two part signal vectors up to half the number of elements in the original signal vector.

The aforementioned calculating instructions are likewise suitable for calculating correction vectors for use directly in the signal vector, wherein the running index k relates in this case to the signal vector and runs from 1 to the number of elements in the signal vector. In this case, obviously only one correction vector has to be calculated.

In an advantageous embodiment the correction vector, prior to addition to the signal vector or a part signal vector, can be multiplied by a window function or windowed. This means that the elements of the correction vector only differ from 0 in at least one limited range. The position of this at least one range is selected in such a way that a maximum value in the signal vector or part signal vector can be reduced thereby. The correction vector is in particular windowed in such a way that it differs from 0 in one range and this range is placed precisely in such a way that a maximum of the signal vector can be reduced thereby. When the maximum vector to be reduced occurs close to an edge of the signal vector, and the range with elements of the windowed correction vector differing from 0 or the window length go beyond the correction vector, the window part going beyond the edge is advantageously received at the other end of the correction vector so the coherent window range is produced on cyclical updating of the correction vector. However, additional spectral components are introduced into the correction vector by the windowing. This means, that depending on the selected window function, a specific number of transmission frequencies close to the sampling frequency of the correction vector are disturbed. If a wide window is used, the range of the disrupted frequencies is low, but with a correction vector windowed in this way the extreme values in the signal vector can be produced in a less targeted or pointwise manner. Conversely when a narrow window is used in order to be able to reduce the extreme values of the signal vector in a target manner, the range of the disrupted frequency in the signal vector widens.

As only part of the signal vector is influenced owing to the windowed correction vector, the crest factor in the signal vector can be reduced several times in succession by a windowed correction vector if the window of the individual correction vectors have a different position.

It is possible in this manner to reduce a plurality of extreme values in the signal vector one after the other, in that one correction vector is used for each extreme value, the correction vector being windowed in such a way that it has values differing from 0 only in one range close to the extreme value, so the remaining ranges of the correction vector in which the elements are 0 do not change the signal vector.

After transmission of the signal vector via a line to the receiver, the received signal vector is converted back into the frequency domain on the receiver side generally by means of a normal Fourier transformation and, in particular a fast Fourier transformation. Generally there is a continuous signal on the transmitter side which is divided for transmission into time sections which are transmitted in the form of a respective signal vector to the receiver. The transmission path to the receiver, owing to inserted filters and the line, has a specific transmission behaviour which causes transient reactions with respect to the signal form of the transmitted signal vector. This has the result that on the receiver side the signal form of the signal vector is more strongly disturbed at the beginning. This makes equalising more difficult on the receiver side, as periodic disturbances which have a uniform effect over the entire length of the received signal vector can be more easily equalised than aperiodic disturbances which only occur in one section of the signal vector and are caused, for example, by the transient reactions. For this reason it may advantageously be provided that the signal vector is lengthened at the front or back by a prefix or a guard interval. For this purpose, part of the signal vector from the opposing second end of the signal vector is added to a first end of the signal vector, the signal vector being lengthened cyclically. If, for example, one part is placed at the end of the signal vector as a prefix in front of the signal vector, the transmission path including all channel and filter distortions during this prefix can already respond, so ideally the transmission path at the beginning of the signal vector is already in the responded state and the received signal vector can be more easily equalised. For this purpose, the signal vector together with the prefix and guard interval are received on the receiver side and only the signal vector without prefix and guard interval is supplied for signal processing by, in particular, inverse Fourier transformation.

If in a transmission method using a prefix and guard interval, the crest factor is to be changed by means of a superimposed correction vector, the following has to be taken into account. The correction vector basically has to be adapted to the length of the signal vector. When the correction vector is superimposed before addition of the prefix or the guard interval, the correction vector has the length of the signal vector, so that with the addition of the prefix or guard interval the already superimposed correction vector is also cyclically updated. If the correction vector is superimposed after addition of the prefix or guard interval, the correction vector has to have the length of the signal vector plus the guard interval. This makes no difference for the calculation of the correction vector if the correction vector has the same signal form over its entire length. With an unwindowed correction vector, the calculation of the correction vector is generally independent of whether the correction vector is superimposed before or after the addition of the prefix or guard interval.

On the other hand, if a windowed correction vector is used this inevitably has no constant signal form over its length. If a windowed correction vector is superimposed before the addition of the prefix or guard interval, the superimposed correction vector is automatically cyclically updated together with the signal vector and can be calculated as described above. If, on the other hand, a windowed correction vector is to be superimposed on a signal vector with an added prefix, account must be taken of where the window range with values of the correction vector differing from 0 lies in relation to the signal vector and the guard interval. If the window range is completely within the signal vector and outside the guard interval, the correction vector and the signal vector can be calculated as described above. If, on the other hand, the window range is at the edge of the signal vector such that it would project beyond an end of the signal vector, the projecting part of the window range must be cyclically updated at the other end of the signal vector, in other words in some circumstances also at the boundary between the guard interval and signal vector and not at the beginning of the vector composed of the guard interval and signal vector.

The invention will be described in more detail hereinafter with the aid of a preferred embodiment and with reference to the accompanying drawings.

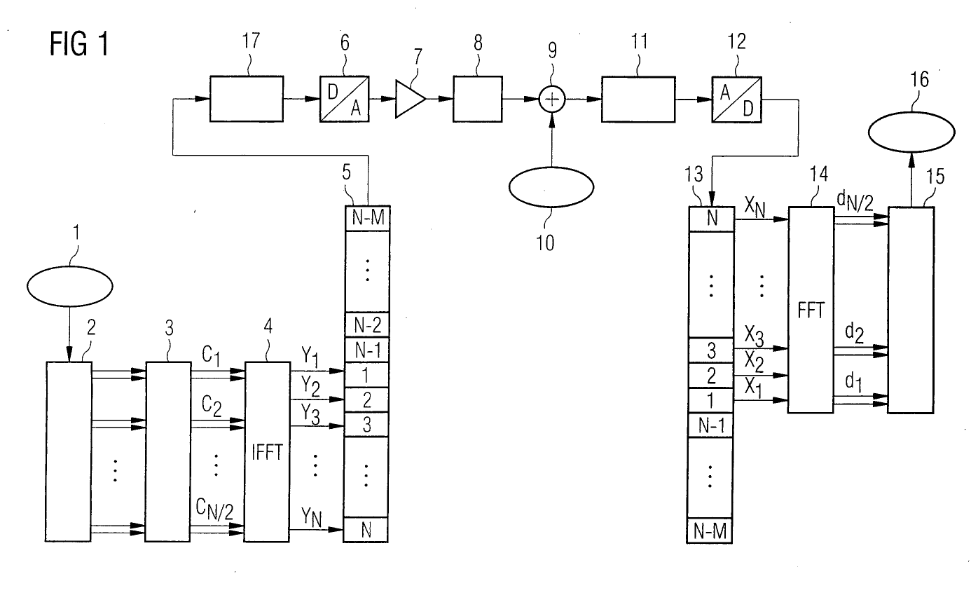

FIG. 1 shows a schematic construction of a circuit arrangement for data transmission by discrete multitone modulation,

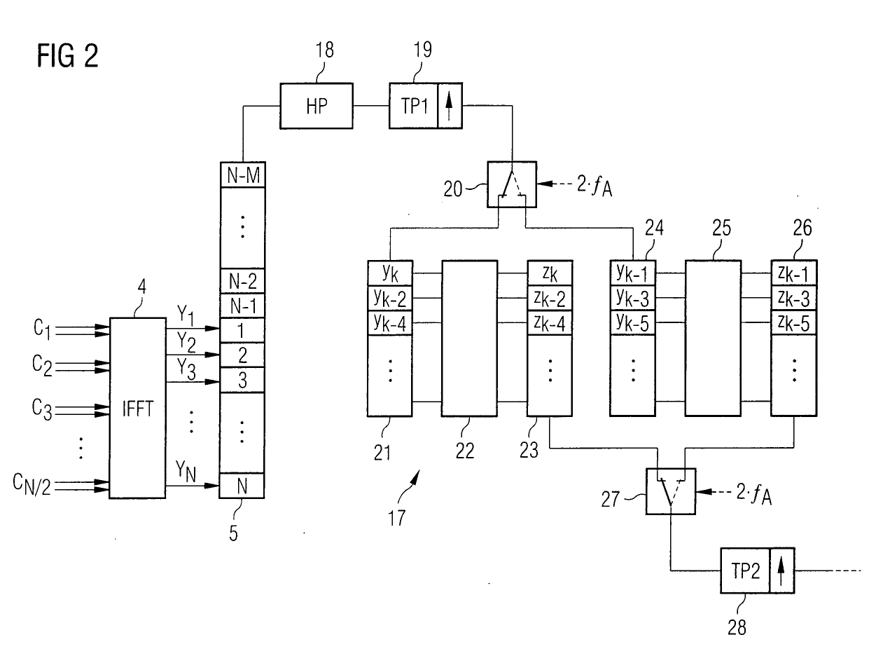

FIG. 2 shows a detail of the circuit arrangement according to FIG. 1 which reproduces in more detail the components for reducing the crest factor,

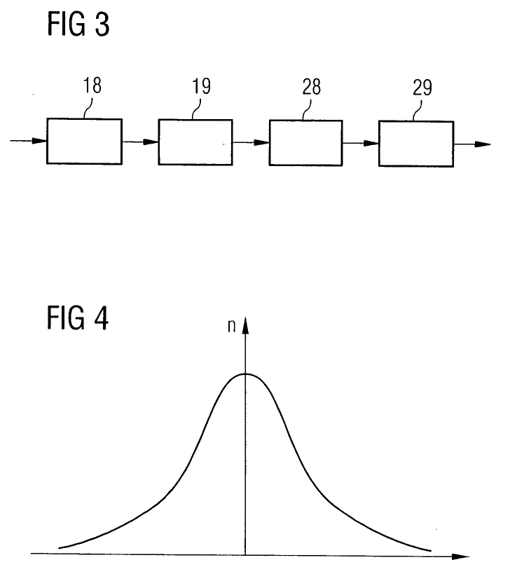

FIG. 3 shows a possible arrangement of filters for processing the transmitted signal, and

FIG. 4 shows the amplitude distribution of the transmitted signal in discrete multitone modulation.

The circuit arrangement shown schematically in FIG. 1 describes a system for data transmission by the method of discrete multitone modulation. A data source 1 transmits digital data here, serially to a first serial/parallel converter 2 which divides the serial data into data blocks with N/2 part blocks in each case. The number N describes the number of elements of the signal vector used for data transmission in the time domain.

The part blocks are transmitted in parallel to the coding device 3 which distributes each of the N/2 part blocks to a respective carrier frequency of the N/2 carrier frequencies available for data transmission and therefore generates a first digital signal vector in the frequency domain with N/2 elements C₁, C₂, . . . , C_{N/2} for amplitude and phase modulation of a respective frequency.

From this signal vector in the frequency domain, a first inverse Fourier transformation 4 generates by an inverse fast Fourier transformation a signal vector y in the time domain with N elements y1, y2, . . . , yN (corresponding to the N sampling values). The N elements of the signal vector y1, y2, . . . , yN in the time domain correspond here to N sampling values of the signal to be transmitted. The signal vector y1, y2, . . . , yN has a high crest factor in the time domain here. This is to be changed and, in particular, reduced. The signal vector y1, y2, . . . , yN in the time domain is transmitted in parallel to a parallel/serial converter 5, in that a prefix is added in front of the signal vector y1, y2, . . . , yN. This prefix is formed from M elements of the signal vector y in the time domain, the M elements being located at the end of the signal vector y before the last element, so that the elements Y_{N-M} to Y_{N-1} are placed in front of the original signal vector y1, y2, . . . , yN. The extended signal vector produced therefrom has N+M elements. This measure is also called a cyclic prefix. It is achieved by the prefix that, at the receiver side, the transient effects are substantially concluded by the beginning of the signal vector y1, y2, . . . , yN and the equalisation can be simplified.

The extended signal vector in the parallel/serial converter 5 is transmitted serially to a correction device 17 which serves to reduce the crest factor and is described below in detail. The correction device 17 supplies output data serially to a digital/analogue converter 7, the analogue output signal of which is amplified by a transmitting amplifier 7 to transmit via a transmission channel 8. In the process the transmission signal from the transmission channel 8 is linearly distorted and superimposed by an addition 9 from a noise component 10. The noise can occur here at many points, for example in the transmission channel 8 owing to crosstalk in the transmitting amplifier 7 or in the digital/analogue converter 6.

There is an equaliser 11 on the receiver side, to which the transmitted signal is supplied and which equalises the signal and passes it to an analogue/digital converter 12. The digital output signal of the analogue/digital converter 12 is supplied serially to a serial/parallel converter 13 which can receive the elements of the signal vector y extended by the prefix. The signal vector with prefix is shifted through to the end in the serial/parallel converter 13, wherein at the end of the shifting operation the prefix is located at the end of the serial/parallel converter 13 and the original signal vector behind it. Only the original signal vector without prefix is transmitted from the serial/parallel converter in parallel as the received signal vector x1, x2, . . . , xN to a second Fourier transformer 14. The received signal vector x1, x2, . . . , xN in the time domain is transmitted back into the frequency domain by the second Fourier transformer 14 by fast Fourier transformation and supplies a received signal vector d1, d2, . . . , dN/2 in the frequency domain with N/2 elements. The receiving signal represented by the signal vector is thus displayed on the various carrier frequencies of the discrete multitone modulation. The received signal vector in the frequency domain d1, d2, . . . , dN/2 is supplied to a receiving stage 15 which calculates the digital data from the amplitude and the phase of the carrier frequencies and supplies them to a data sink 16.

FIG. 2 shows in detail a section of the circuit arrangement according to FIG. 1 around the correction device 17. As described above the first Fourier transformer 4 supplies a signal vector y in the time domain which is provided in the parallel/serial converter 5 with a prefix and output serially as an extended signal vector in the time domain. The extended signal vector in the time domain passes through a digital high-pass filter 18, in which the spectral components in a lower frequency range which is used for transmitting telephone conversations via a telephone line, are removed. The signal vector then passes through a first low-pass filter 19 which removes the spectral components above the Nyquist frequency. For this purpose in the first low-pass filter 19 the sampling frequency is doubled which is signalled by the upwardly directed arrow. The extended signal vector in the time domain with the doubled sampling frequency f_{A} and therefore double the number of elements is therefore at the output of the first low-pass filter 19. The output signal of the first low-pass filter 19 is guided to a first converter 20 which, in the clock pulse of the doubled sampling frequency f_{A} divides the elements over two part signal vectors which are each loaded into one of two part signal vector registers 21, 24. The elements of the extended signal vector from the output of the first low-pass filter 19 are then alternately distributed over the two part signal vectors. The first part signal vector therefore receives the elements of the extended signal vector which has been doubled with respect to sampling frequency in the time domain with an even time index, in other words the elements Yₖ, Yₖ₋₂, Yₖ₋₄, . . . , whereas the second part signal vector contains the elements with an uneven time index Yₖ₋₁, Yₖ₋₃, Yₖ₋₅, . . . , wherein k is the running index for the elements of the extended signal vector which has been doubled with respect to sampling frequency and therefore runs to 2N.

The two part signal vector registers 21 and 24 supply the two part signal vectors Yₖ, Yₖ₋₂, . . . , and Yₖ₋₁, Yₖ₋₃, . . . , to a first and second part correction device 22 or 25, respectively. In each of these two part correction devices 22 and 25, a correction vector is calculated as a function of the respective part signal vector present, is superimposed on the signal vector or is added thereto and a part output vector z is output as a result of this superposition. A first part output vector with an even time index having the elements zₖ, zₖ₋₂, zₖ₋₄, . . . , is generated by the first part correction device 22. The part output vector generated by the,second part correction device 25 comprises the elements with uneven time index zₖ₋₁, zₖ₋₃, zₖ₋₅, . . . . The two part output vectors are written parallel to the part output registers 23, 26 from which they can be serially output. The output signals of the two part output registers 23, 26 are guided to a second converter 27 which is clocked synchronously to the first converter 20 with double the sampling frequency 2f_{A} and the elements of the two part output vectors are alternately joined in the two part output registers 23, 26 to form a single vector which again comprises 2N elements. The extended signal vector doubled with respect to the sampling frequency and supplied by the first low-pass filter 19 is therefore at the output of the second converter 27 in the time domain in which a reduction of the crest factor was also undertaken. The same operation which is described below, takes place inside each of the two part correction devices 22, 25.

A correction vector is basically used which has only spectral components at the sampling frequency f_{A/2}, so it can be generated by scaling a vector with the elements +1, −1, . . . . This sequence of alternately +1 and −1 is scaled in such a way that a maximum value in the part signal vector and also the crest factor is reduced. Simultaneously, the information in the frequency channels is not disturbed by a correction vector of this type as a correction vector of this type only adds frequency components at the Nyquist frequency which is not used for data transmission.

To describe the calculation of a correction vector, a new running index i is to be introduced hereinafter which continuously numbers the elements of a part signal vector. This new running index i runs from 1 to N. The correction vector for the first part signal vector should be denoted Δy1 and the first part signal vector y1. Proceeding therefrom, the first correction vector Δy1 is calculated as follows:

$$Δ {y1}_{i} = - \frac{1}{2} \cdot {( - 1 )}^{i} ( max ( {( - 1 )}^{i} \cdot {y1}_{i} ) + min ( {( - 1 )}^{i} \cdot y1 , ) )$$

In this instance max designates the largest element of a vector and min the smallest element of a vector. The second correction vector for use in the second part correction device 25 is calculated analogously, wherein a second part signal vector y2ᵢ containing the elements yₖ₋₁, yₖ₋₃, yₖ₋₅, . . . , takes the place of the first part signal vector y1ᵢ. A second correction vector Δy2ᵢ is calculated in a corresponding manner.

The two part output vectors zₖ, zₖ₋₂, zₖ₋₄, . . . , and zₖ₋₁, zₖ₋₃, zₖ₋₅, . . . , are calculated by addition of the first part signal vector y1 and the second part signal vector y2 to the first correction vector Δy1 and the second correction vector Δy2.

The extended signal vector doubled with respect to sampling frequency generated at the output of the second converter 27 passes through a second low-pass filter 28, in which the sampling frequency is increased again to four times the original sampling frequency f_{A}. The two low-pass filters 19 and 28 are set up in such a way that the first low-pass filter 19 causes a greater change in the frequency spectrum in comparison to the second low-pass filter 28 and therefore the second low-pass filter 28 results in a lower rise in the crest factor in the signal.

FIG. 3 shows how a chain of filters can be looped in the system according to FIG. 1 between the parallel/serial converter 5 and the digital/analogue converter 6. The correction device 17 can be inserted to reduce the crest factor at any point within this filter chain. In the configuration of the correction device 17 shown in FIG. 2, it is necessary for a signal with the doubled sampling frequency f_{A} to be at the input of the first converter 20. Therefore, the set-up has to be such that a signal with the doubled sampling frequency f_{A} is at the first converter 20 owing to the point at which the correction device 17 is arranged inside the filter chain and the configuration of the filter blocks located prior thereto. If, for example, a plurality of low-pass filters are to be provided prior to the collection device 17, these must be set up in such a way that in total they only increase the sampling frequency to double. In the case shown in FIG. 3 the correction device 17 would be arranged between the first low-pass filter 19 and the second low-pass filter 28. A third low-pass filter 29 in which the sampling frequency can optionally be doubled again, can adjoin the second low-pass filter 28.

1. Method for changing the crest factor of a discrete-time signal which is formed from temporally consecutive signal values of a signal vector, in which method, as a function of the signal vector, at least one correction vector is calculated and added to the signal vector, wherein the signal described by the signal vector is first filtered and then, as a function of the filtered signal vector, at least one correction vector is calculated and added to the filtered signal vector.

2. Method according to claim 1, wherein the signal described by the signal vector is high-pass filtered and/or low-pass filtered.

3. Method according to claim 1, wherein the signal is a carrier of data, all spectral components of the data lying below the sampling frequency of the signal divided by 2^{(N+1)}, wherein the signal values of the signal vector after filtering are divided over 2^{N} part signal vectors in a cyclically alternating manner and for each part signal vector at least one correction vector is calculated independently from the respective part signal vector and added to the respective part signal vector, and then the elements of the part signal vectors are combined in a cyclically alternating manner into an output signal vector, where N is integral and ≧1.

4. Method according to claim 3, wherein N=1.

5. Method according to claim 1, wherein the at least one correction vector is calculated by scaling of at least one output correction vector.

6. Method according to claim 5, wherein the at least one output correction vector contains exclusively spectral components in frequency ranges which are different to frequency ranges which are used to transmit data in the signal.

7. Method according to claim 5, wherein the elements of the at least one correction vector are calculated from the largest element and the smallest element of the elements of the digital signal vector as follows:
$$Δ {y}_{k} = - \frac{1}{2} \cdot {( - 1 )}^{k} ( max ( {( - 1 )}^{k} \cdot {y}_{k} ) + min ( {( - 1 )}^{k} \cdot {y}_{k} ) ) ,$$
where k=1, . . . , number of the elements of the signal vector.

8. Method according to claim 5, wherein the elements of the at least one correction vector are calculated from the largest element and the smallest element of the elements of the digital signal vector as follows:
$$Δ {y}_{k} = - \frac{1}{2} \cdot ( max ( {y}_{k} ) + min ( {y}_{k} ) ) ,$$
where k=1, . . . , number of the elements of the signal vector (y).

9. Method according to claim 1, wherein the elements of the at least one correction vector are multiplied by a window function, so that the elements of the at least one correction vector are 0 in at least one range.

10. Method according to claim 9, wherein the steps of calculating at least one correction vector as a function of the signal vector and the addition of the calculated at least one correction vector to the signal vector are repeated at least once.

11. Method according to claim 1, wherein the signal vector at the beginning of a first end is extended by at least one element of the signal vector beginning from the opposing second end of the signal vector.

12. Method according to claim 11 and claim 9, wherein the extension of the signal vector at the first end is carried out at the beginning of the method and the at least one windowed correction vector is extended corresponding to the extension of the signal vector at a first end of the windowed correction vector by at least one consecutive element of the windowed correction vector starting at the opposing second end of the windowed correction vector, so that the windowed correction vector and the signal vector are extended by the same number of elements.

13. Method according to claim 1, wherein the signal vector is calculated by inverse Fourier transformation.

14. Method according to claim 1, wherein the signal vector contains data according to the method of discrete multitone modulation.

15. Method according to claim 1, wherein the method for data transmission via telephone lines is used according to the ADSL standard.

16. Device for changing the crest factor of a discrete-time signal which is formed from temporally consecutive signal values of a signal vector, wherein the device is set up in such a way that, as a function of the signal vector at least one correction vector is calculated and added to the signal vector, wherein the device is set up in such a way that the signal described by the signal vector is first filtered and then at least one correction value is calculated as a function of the filtered signal vector and is added to the signal vector.

17. Device according to claim 16, wherein the device is set up to carry out a method according to any one of claims 1 to 15.

18. Device according to claim 16, wherein the device is a signal processor.
